(19) United States
(12) Patent Application Publication
(10) Pub. No.: US 2024/0427089 A1
(43) Pub. Date: Dec. 26, 2024

(54) EXTENSION FOR MULTI-PORT FIBER OPTIC CABLE CONNECTOR ADAPTER SYSTEMS

(71) Applicant: Sumitomo Electric Lightwave Corp., Raleigh, NC (US)

(72) Inventors: Guilherme Doro Roncoleta, Irvine, CA (US); Daizo Nishioka, Irvine, CA (US)

(21) Appl. No.: 18/749,833

(22) Filed: Jun. 21, 2024

Related U.S. Application Data
(60) Provisional application No. 63/522,448, filed on Jun. 22, 2023.

(51) Int. Cl. G02B 6/38

(52) U.S. Cl. CPC G02B 6/3825

(57) ABSTRACT

A connector adapter for coupling cables together. The connector adapter has a housing, ports formed within the housing, and at least one extension that is attached to the first lateral side of the housing and extends away from the housing. A first subset of ports is formed on a first lateral side of the housing, and a second subset of ports is formed on a second lateral side of the housing. The first extension supports and guides a connector attached to one of the cables into one of the first subset of the ports during insertion of the connector therein. The first subset of ports extends into the housing, towards the second subset of ports. The second subset of ports extends into the housing, towards the first subset of ports.

### CROSS-REFERENCE TO RELATED APPLICATION

This application claims priority to U.S. Provisional Patent Application Ser. No. 63/522,448, filed on Jun. 22, 2023, the disclosure of which is incorporated by reference herein in its entirety.

### BACKGROUND

The rapid growth of e-commerce, video streaming services, and cloud computing services requires a commensurate rapid growth in computing infrastructure, including locations commonly referred to as “datacenters.” In order for a datacenter to be operational, however, not only must each of the computer servers be installed within racks in the datacenter and provided with power, but these computer servers must also be interconnected together and/or with communications equipment (e.g., switches) that is also provided within such datacenters, such that data can be transferred to, from, and/or between each of these computer servers for performing a designated function.

Due to the proliferation of high-speed internet connections for users, the need for increased data transmission bandwidth continues to increase. One of the most efficient data transfer cable mediums is fiber optic cable, through which a signal can travel at speeds approaching the speed of light. However, such fiber optic cables must first be “terminated,” meaning to have a connector rigidly attached to the end of the fiber optic cable. These connectors allow for a rigid connection between the fiber optic cable and the computer infrastructure device (e.g., computer or switch) that ensures uninterrupted receipt/transmission of data through the fiber optic cable, while also protecting the fiber optic cable from being damaged.

When building a datacenter, data transmission cables, such as fiber optic cables, must be connected between computer servers and/or switches. However, the act of “terminating” a fiber optic cable is very time and labor intensive. Thus, pre-terminated cables can be used to significantly reduce the amount of time required to bring new datacenters online, since the cable termination step can then be omitted. It is often necessary for fiber optic cables to be connected to an adapter mounted within a panel. However, the handling of such pre-terminated cables by datacenter installation personnel and the connection of such pre-terminated cables to an adapter is cumbersome at present. Thus, a need exists for a device suitable for use with such adapters that simplifies the installation of such pre-terminated cables in the adapters.

### BRIEF DESCRIPTION OF THE DRAWINGS

One or more example embodiments of the disclosed device are described herein, with reference to the accompanying drawings, in which:

FIG. 1 is a schematic illustration showing the internal construction of an example fiber optic cable.

FIG. 2 is a perspective view of a first example embodiment of a fiber optic connector adapter that has 2 ports.

FIG. 3 is a side view of the fiber optic connector adapter shown in FIG. 2.

FIG. 4 is a perspective view of a second example embodiment of a fiber optic connector adapter that has 4 ports.

FIG. 5 is a side view of the fiber optic connector adapter shown in FIG. 4.

FIG. 6 is a perspective view of a third example embodiment of a fiber optic connector adapter that has 1 port.

FIG. 7 is a perspective view of a fourth example embodiment of a fiber optic connector adapter that has 8 ports.

FIG. 8 is a perspective view of a fifth example embodiment of a fiber optic connector adapter that has 12 ports.

The drawings are not necessarily to scale. The drawings are merely representations, not intended to portray specific parameters of the disclosure. The drawings are intended to depict example embodiments of the disclosure, and therefore are not to be considered as limiting in scope. In the drawings, like numbering represents like elements.

### DETAILED DESCRIPTION

Example embodiments of a connector adapter in accordance with the present disclosure will now be described more fully hereinafter with reference to the accompanying drawings, in which preferred embodiments of the present disclosure are presented. The connector adapter(s) of the present disclosure may, however, be embodied in many different forms and should not be construed as being limited to the embodiments set forth herein. Rather, these embodiments are provided so that this disclosure will convey certain example aspects of such connector adapter(s) to those skilled in the art. In the drawings, like numbers refer to like elements throughout unless otherwise noted.

The example embodiments of the connector adapters are configured for use with (e.g., to have inserted therein) fiber optic cable connectors. These fiber optic cables can be either pre-terminated or terminated with connectors in situ before such connectors are plugged into one of the ports of the connector adapter. In some embodiments, the connector adapters may be designed so as to be operable with cable types other than fiber optic cables.

The connector adapters shown herein are designed as a way to provide a secure and robust connection between a respective connector of two cables. Thus, each port on one side of the connector adapter is arranged substantially coaxial to a corresponding one of the ports on the other, opposite side of the connector adapter. The core of each fiber optic cable installed into one of the coaxially-aligned pairs of ports of the connector adapter is thus also substantially coaxially aligned when the connector of each respective cable is installed within one of the coaxially-aligned pairs of ports of the connector adapter. Thus, by plugging a connector of a first cable into a first port and by plugging a connector of a second cable into an outlet port, the first port and the second port being coaxially aligned with each other, a signal may be transmitted between the first cable and the second cable, specifically, between the core of the fiber in the first cable and the core of the fiber in the second cable, thereby minimizing signal loss through the connector adapter.

The connector adapters disclosed herein are designed and configured to maximize the flexibility of movements of the cables during maintenance and/or installation actions performed with respect to the cables within the datacenter. Such connector adapters do not interfere with the cable or connector efficiency and/or workability. The connector adapters have a construction that advantageously reduces the costs associated with maintenance and/or installation actions and also reduces the risk of damage to the fiber optic cables due to improper handling or movements (e.g., excessive bending, improper application of insertion force to the cable etc.) of the fiber optic cable, which is known to cause reduced signal transmission performance.

In order to effectuate these benefits, each of the connector adapters comprises, extending from each lateral side thereof in opposite directions, an extension that supports and guides the connector into an associated one of the ports of the connector adapter during the cable insertion process, which avoids damage to the core, or ferrule, during cable maintenance and/or installation actions.

Through the use of such extensions on the connector adapters, the workability of the cable installation is enhanced, and the time associated with maintenance and/or installation actions for insertion of a cable connector is reduced, commensurately reducing the cost associated with such maintenance and/or installation actions. Such extensions prevent the occurrence of restricted movements during the cable insertion process by acting as a guide for the connector and also protecting the ferrule of the connector from damage during the cable insertion process.

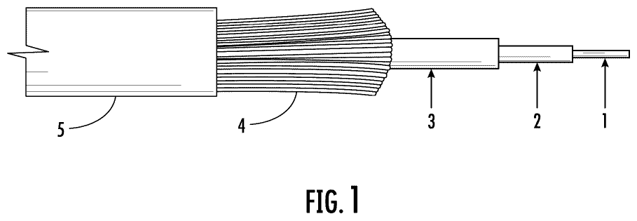

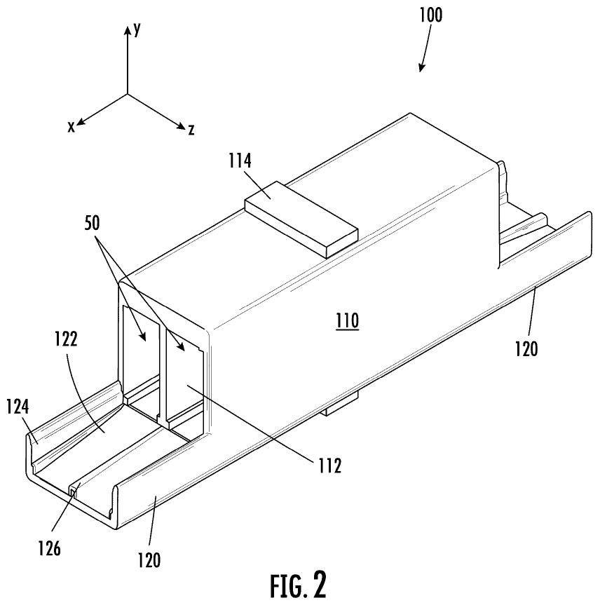

Referring to FIG. 1, an example embodiment of a conventional fiber optic is shown. There is a core 1 at the center of the cable. In some instances, the core 1 may comprise multiple fiber optic filaments. The filaments can also be referred to as ferrules. The core 1 is surrounded by a cladding layer 2. In some instances, each filament of a multi-filament fiber optic cable may have its own cladding layer 2. The cladding layer(s) 2 is/are surrounded by a coating layer 3. Strengthening fibers 4 are provided around the coating layer 3 and are surrounded by an outer cable jacket 5. When terminated, the filament(s) of the core 1 are inserted and secured within a connector such that, when the connector is inserted within a port (see, e.g., ports 50, FIGS. 2, 4, and 6-8) of a connector adapter (see, e.g., connector adapters 100, 200, 300, 400, 500), the connector is held in a prescribed position and, commensurately, the filament(s) of the core 1 is/are also held in a prescribed position by engagement of the connector with the port of the connector adapter. It is these connectors, attached to the fiber optic cable generally of the type shown in FIG. 1, that are installed into the fiber optic connector adapters disclosed herein, example embodiments of which are shown in FIGS. 2-8.

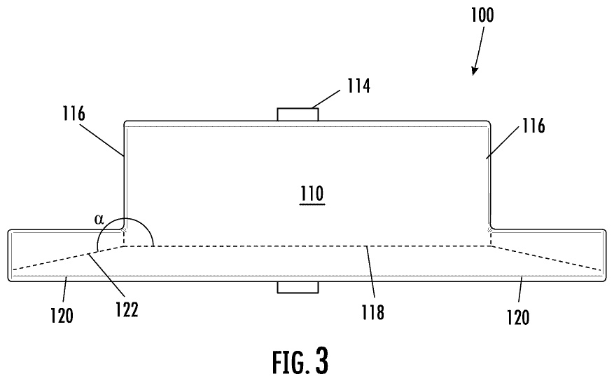

FIGS. 2 and 3 show a first example embodiment of a multi-port fiber optic connector adapter, generally designated 100. The connector adapter 100 comprises a housing 110, in which a plurality of ports, generally designated 50, are formed on opposing lateral sides 116 of the housing 110. Thus, there are ports 50 formed on both lateral sides 116 of the housing 110, including a first subset of two (2) ports 50 formed on a first lateral side 116 of the housing 110 and a second subset of two (2) ports 50 formed on a second lateral side 116 of the housing 110. Each port 50 of the first subset of ports 50 extends towards a corresponding port 50 of the second subset of ports 50, such that a plurality of cavities or passages (e.g., volumetric regions) are formed extending between one of the ports 50 of the first subset of ports 50 and a coaxially aligned one of the ports 50 of the second subset of ports 50. Thus, there are as many cavities defined through the housing 110 as there are pairs of ports 50 on the opposing lateral sides 116 of the housing 110. In the example embodiment shown, the cavities are fully separated or isolated from each other in the z-direction by internal walls 112, which extend the full height of the cavity formed by such internal wall 112 within the housing 110. In some embodiments, the internal walls 112 may extend over only a portion of the height of the housing 110, in which case the cavities extending between respective pairs of ports 50 would not be separated or isolated from each other in the z-direction.

The connector adapter 100 comprises an extension 120 that extends away from the housing 110 in the x-direction from both of the lateral walls 116 of the housing 110. The extension 120 has side walls 124 that are generally coplanar with the outer (e.g., in the z-direction, extending in the x-y plane) side walls of the housing 110, such that the side walls 124 extend generally in the y-z plane. A ramp 122, or sloped surface, is provided between the side walls 124 of the extension 120. The extension 120 comprises dividers 126 (e.g., walls) that are spaced apart from each other in the z-direction and extend along the ramp 122 in the x-direction. The dividers 126 are each formed so as to have a top surface that is substantially coplanar with each other and extending in the x-z plane. A distance between the upper (e.g., in the y-direction) edges of the side walls 124 of the extension 120 and the sloped surface of the ramp 122 changes along the length of the extension in the x-direction. A distance between the upper (e.g., in the y-direction) edges of the dividers 126 of the extension 120 and the sloped surface of the ramp 122 also changes along the length of the extension in the x-direction. As shown, the dividers 126 can have a height above the sloped surface of the ramp 122 that decreases as a function of proximity to the lateral side 116 of the housing 110 to which the extension 120 is attached. The dividers 126 of the extension 120 are preferably coplanar with the internal walls 112 or other dividers within the housing 110 that define the respective cavities within the housing 110.

The sloped surface of the ramp 122 tapers generally away from the lateral side 116 of the housing 110 to which the extension 120 is attached. Thus, the sloped surface of the ramp 122 is, at the end farthest away from the lateral side 116 of the housing 110, lower (i.e., in the y-direction) than where the extension 120 is connected at the lateral side 116 of the housing 110. Stated somewhat differently, the sloped surface of the ramp 122 is inclined such that an angle α between the surfaces of the ramp 122 and cavity contacted by the connector is greater than 180°, as shown in FIG. 3.

The dividers 126 define channels therebetween, each channel being aligned with (e.g., coaxial to) one of the ports 50 of the connector adapter 100 on the same side of the housing 110 on which the extension 120 is attached. For the connector adapter 100, the quantity of channels, which are formed by and between the side walls 124 and dividers 126 (e.g., the outermost channels, in the z-direction) and between adjacent dividers 126 (e.g., the inner channels), is the same as the quantity of ports 50 of the connector adapter 100. The distance between (e.g., in the z-direction) the dividers 126 is the same as or wider than the width of the connector to be inserted within the port 50 of the connector adapter 100. Thus, during insertion, the connector rests on the ramp 122 within one of the channels, which corresponds to the port 50 into which the connector is to be inserted, and can be slid along the ramp 122 in the direction of insertion (e.g., in the x-direction), such that this channel guides the connector into the port 50 of the connector adapter 100 designated to receive the connector therein. Thus, the extension 120 is configured to align each connector with one of the ports 50 into which the connector is to be inserted, such that an alignment of the connector and said port 50 is maintained by engagement of the connector within the corresponding channel as the connector is moved towards the port 50 designated to receive the connector therein. The extension 120 is configured such that the act of placing the connector within one of the channels self-aligns the connector with the port 50 associated with the channel. Thus, by using the extensions 120 described herein, misalignments between the cable connector and the port 50 that are known to cause damage to the ferrules of the fiber optic cable connector are advantageously prevented.

In some embodiments, only one lateral side 116 of the housing 110 may have an extension 120 attached thereto.

In some embodiments, the housing 110 and the extensions 120 are formed integrally. Preferably, the extensions 120 and the housing 110 are formed in a unitary manner, such as via an injection molding process. The housing 110 and the extensions 120 can be formed out of any suitable material, including plastic, ceramic, and/or metal.

The housing 110 has a fastener 114 configured to secure the housing 110 to a panel, such as a network patch panel. Any suitable fastener type may be used. The fastener is preferably of a type by which the housing 110 may be inserted and removed from the panel in a tool-less manner (e.g., manually).

Thus, during a method of use of the connector adapter 100, a connector attached at a terminal end of a fiber optic cable can be positioned to rest within a designated channel, the connector can be slid along the ramp 122 towards the port 50 into which such connector is to be inserted, and the connector can be inserted into such port 50 when the connector reaches the end of the ramp 122 at the lateral side 116 of the housing 110.

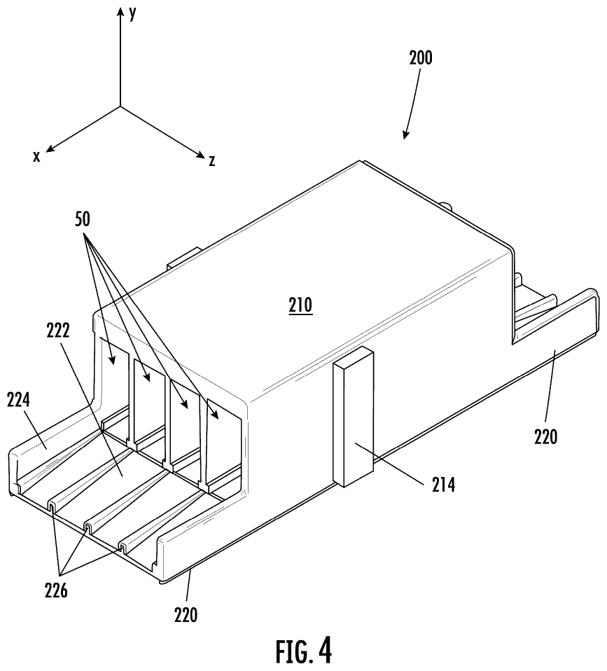

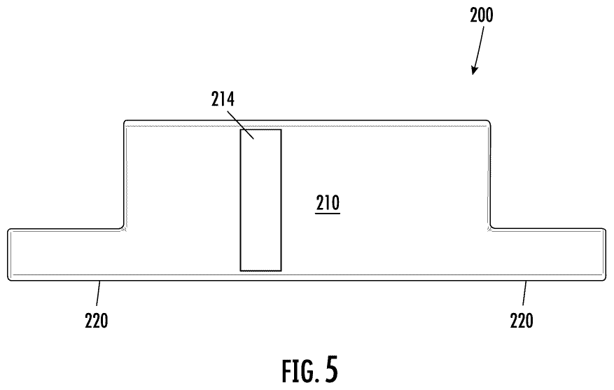

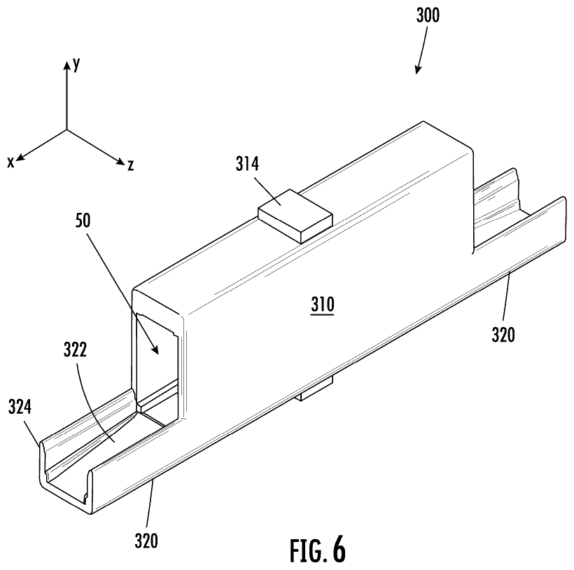

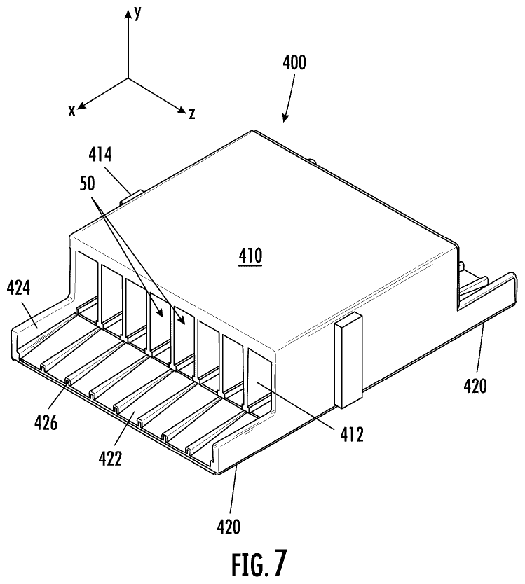

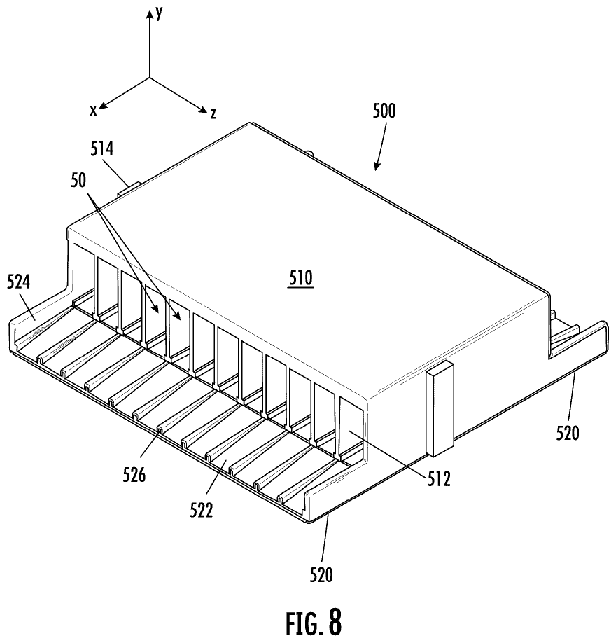

FIGS. 4-8 show various alternative example embodiments for connectors adapters 200, 300, 400, 500, in which the quantity, or number, of ports 50 differs. The quantity of ports 50, however, is not limited to those shown and includes any suitable or desired quantity of ports 50 without limitation. Thus, in the example embodiment of the connector adapter shown in FIGS. 4 and 5, the connector adapter has four (4) ports 50 on each lateral side 116 of the housing 110. In the example embodiment of the connector adapter shown in FIG. 6, the connector adapter has only a single port 50 on each lateral side 116 of the housing 110. In the example embodiment of the connector adapter shown in FIG. 7, the connector adapter has eight (8) ports 50 on each lateral side 116 of the housing 110. In the example embodiment of the connector adapter shown in FIG. 8, the connector adapter has twelve (12) ports 50 on each lateral side 116 of the housing 110. Structures in the example embodiments shown in FIGS. 4-8 that appear similar to the structures of the example embodiment shown in FIGS. 2 and 3 are not expressly described herein, but are substantially identical in form and function to the description of such structures with respect to the description of FIGS. 2 and 3.

FIGS. 4 and 5 show a second example embodiment of a multi-port fiber optic connector adapter, generally designated 200. The connector adapter 200 comprises a housing 210, in which a plurality of ports, generally designated 50, are formed on opposing lateral sides 216 of the housing 210. Thus, there are ports 50 formed on both lateral sides 216 of the housing 210, including a first subset of four (4) ports 50 formed on a first lateral side 216 of the housing 210 and a second subset of four (4) ports 50 formed on a second lateral side 216 of the housing 210. Each port 50 of the first subset of ports 50 extends towards a corresponding port 50 of the second subset of ports 50, such that a plurality of cavities or passages (e.g., volumetric regions) are formed extending between one of the ports 50 of the first subset of ports 50 and a coaxially aligned one of the ports 50 of the second subset of ports 50. Thus, there are as many cavities defined through the housing 210 as there are pairs of ports 50 on the opposing lateral sides 216 of the housing 210. In the example embodiment shown, the cavities are fully separated or isolated from each other in the z-direction by internal walls 212, which extend the full height of the cavity formed by such internal wall 212 within the housing 210. In some embodiments, the internal walls 212 may extend over only a portion of the height of the housing 210, in which case the cavities extending between respective pairs of ports 50 would not be separated or isolated from each other in the z-direction.

The connector adapter 200 comprises an extension 220 that extends away from the housing 210 in the x-direction from both of the lateral walls 216 of the housing 210. The extension 220 has side walls 224 that are generally coplanar with the outer (e.g., in the z-direction, extending in the x-y plane) side walls of the housing 210, such that the side walls 224 extend generally in the y-z plane. A ramp 222, or sloped surface, is provided between the side walls 224 of the extension 220. The extension 220 comprises dividers 226 (e.g., walls) that are spaced apart from each other in the z-direction and extend along the ramp 222 in the x-direction. The dividers 226 are each formed so as to have a top surface that is substantially coplanar with each other and extending in the x-z plane. A distance between the upper (e.g., in the y-direction) edges of the side walls 224 of the extension 220 and the sloped surface of the ramp 222 changes along the length of the extension in the x-direction. A distance between the upper (e.g., in the y-direction) edges of the dividers 226 of the extension 220 and the sloped surface of the ramp 222 also changes along the length of the extension in the x-direction. As shown, the dividers 226 can have a height above the sloped surface of the ramp 222 that decreases as a function of proximity to the lateral side 216 of the housing 210 to which the extension 220 is attached. The dividers 226 of the extension 220 are preferably coplanar with the internal walls 212 or other dividers within the housing 210 that define the respective cavities within the housing 210.

The sloped surface of the ramp 222 tapers generally away from the lateral side 216 of the housing 210 to which the extension 220 is attached. Thus, the sloped surface of the ramp 222 is, at the end farthest away from the lateral side 216 of the housing 210, lower (i.e., in the y-direction) than where the extension 220 is connected at the lateral side 216 of the housing 210. Stated somewhat differently, the sloped surface of the ramp 222 is inclined such that an angle α between the surfaces of the ramp 222 and cavity contacted by the connector is greater than 180° (see, e.g., FIG. 3, as this is omitted from the view shown in FIG. 5 for clarity).

The dividers 226 define channels therebetween, each channel being aligned with (e.g., coaxial to) one of the ports 50 of the connector adapter 200 on the same side of the housing 210 on which the extension 220 is attached. For the connector adapter 200, the quantity of channels, which are formed by and between the side walls 224 and dividers 226 (e.g., the outermost channels, in the z-direction) and between adjacent dividers 226 (e.g., the inner channels), is the same as the quantity of ports 50 of the connector adapter 200. The distance between (e.g., in the z-direction) the dividers 226 is the same as or wider than the width of the connector to be inserted within the port 50 of the connector adapter 200. Thus, during insertion, the connector rests on the ramp 222 within one of the channels, which corresponds to the port 50 into which the connector is to be inserted, and can be slid along the ramp 222 in the direction of insertion (e.g., in the x-direction), such that this channel guides the connector into the port 50 of the connector adapter 200 designated to receive the connector therein. Thus, the extension 220 is configured to align each connector with one of the ports 50 into which the connector is to be inserted, such that an alignment of the connector and said port 50 is maintained by engagement of the connector within the corresponding channel as the connector is moved towards the port 50 designated to receive the connector therein. The extension 220 is configured such that the act of placing the connector within one of the channels self-aligns the connector with the port 50 associated with the channel. Thus, by using the extensions 220 described herein, misalignments between the cable connector and the port 50 that are known to cause damage to the ferrules of the fiber optic cable connector are advantageously prevented.

In some embodiments, only one lateral side 216 of the housing 210 may have an extension 220 attached thereto.

In some embodiments, the housing 210 and the extensions 220 are formed integrally. Preferably, the extensions 220 and the housing 210 are formed in a unitary manner, such as via an injection molding process. The housing 210 and the extensions 120 can be formed out of any suitable material, including plastic, ceramic, and/or metal.

The housing 210 has a fastener 214 configured to secure the housing 210 to a panel, such as a network patch panel. Any suitable fastener type may be used. The fastener is preferably of a type by which the housing 210 may be inserted and removed from the panel in a tool-less manner (e.g., manually).

Thus, during a method of use of the connector adapter 200, a connector attached at a terminal end of a fiber optic cable can be positioned to rest within a designated channel, the connector can be slid along the ramp 222 towards the port 50 into which such connector is to be inserted, and the connector can be inserted into such port 50 when the connector reaches the end of the ramp 222 at the lateral side 216 of the housing 210.

The fiber optic connector adapters shown in FIGS. 2-5 are merely examples and the fiber optic connector adapters disclosed herein are not limited to having any specific quantity of ports 50. Further examples of fiber optic connector adapters are shown in FIG. 6 (single port), 7 (8 ports), and 8 (12 ports). These examples of FIGS. 6-8 are not to be construed as limiting and fiber optic connector adapters according to the subject matter disclosed herein can include any desired quantity of ports 50 that can be fit within and supported by a network patch panel. Specifically, the fiber optic connector adapters according to the subject matter disclosed herein can include any quantity of ports 50, from 1 port 50 to 12 ports 50 or even more than 12 ports 50.

FIG. 6 shows a third example embodiment of a single-port fiber optic connector adapter, generally designated 300. The connector adapter 300 comprises a housing 310, in which a single port, generally designated 50, is formed on opposing lateral sides (e.g., in the x-direction) of the housing 310. Thus, there is a single port 50 formed on both lateral sides of the housing 310, including a first port 50 formed on a first lateral side of the housing 310 and a second port 50 formed on a second lateral side of the housing 310. The first port 50 extends towards the second port 50, such that a single cavity or passage (e.g., volumetric region) is formed extending between the first and second ports 50 (e.g., in the x-direction), the first port 50 being coaxially aligned with the second port 50. Thus, there are as many cavities defined through the housing 310 as there are pairs of ports 50 on the opposing lateral sides of the housing 310.

The connector adapter 300 comprises an extension 320 that extends away from the housing 310 in the x-direction from both of the lateral walls of the housing 310. The extension 320 has side walls 324 that are generally coplanar with the outer (e.g., in the z-direction, extending in the x-y plane) side walls of the housing 310, such that the side walls 324 extend generally in the y-z plane. A ramp 322, or sloped surface, is provided between the side walls 324 of the extension 320. A distance between the upper (e.g., in the y-direction) edges of the side walls 324 of the extension 320 and the sloped surface of the ramp 322 changes along the length of the extension in the x-direction.

The sloped surface of the ramp 322 tapers generally away from the lateral side of the housing 310 to which the extension 320 is attached. Thus, the sloped surface of the ramp 322 is, at the end farthest away from the lateral side of the housing 310, lower (i.e., in the y-direction) than where the extension 320 is connected at the lateral side of the housing 310. Stated somewhat differently, the sloped surface of the ramp 322 is inclined such that an angle α between the surfaces of the ramp 322 and cavity contacted by the connector is greater than 180° (see, e.g., FIG. 3, as the side view of the connector adapter 300 is substantially identical to the side view of the connector adapter 100, shown in FIG. 3).

The side walls 324 define a single channel therebetween. This channel is aligned with (e.g., coaxial to) the port 50 of the connector adapter 300 on the same side of the housing 310 on which the extension 320 is attached. Thus, during insertion, the connector rests on the ramp 322 within the channel and can be slid along the ramp 322 in the direction of insertion (e.g., in the x-direction), such that this channel guides the connector into the port 50 of the connector adapter 300. Thus, the extension 320 is configured to align the connector with the port 50 into which the connector is to be inserted, such that an alignment of the connector and the port 50 is maintained by engagement of the connector within the channel as the connector is moved towards the port 50 designated to receive the connector therein. The extension 320 is configured such that the act of placing the connector within the channel self-aligns the connector with the port 50. Thus, by using the extensions 320 described herein, misalignments between the cable connector and the port 50 that are known to cause damage to the ferrules of the fiber optic cable connector are advantageously prevented.

In some embodiments, only one lateral side 316 of the housing 310 may have an extension 320 attached thereto.

In some embodiments, the housing 310 and the extensions 320 are formed integrally. Preferably, the extensions 320 and the housing 310 are formed in a unitary manner, such as via an injection molding process. The housing 310 and the extensions 120 can be formed out of any suitable material, including plastic, ceramic, and/or metal.

The housing 310 has a fastener 314 configured to secure the housing 310 to a panel, such as a network patch panel. Any suitable fastener type may be used. The fastener is preferably of a type by which the housing 310 may be inserted and removed from the panel in a tool-less manner (e.g., manually).

Thus, during a method of use of the connector adapter 300, a connector attached at a terminal end of a fiber optic cable can be positioned to rest within the channel, the connector can be slid along the ramp 322 towards the port 50 into which such connector is to be inserted, and the connector can be inserted into such port 50 when the connector reaches the end of the ramp 322 at the lateral side of the housing 310.

FIG. 7 shows a fourth example embodiment of a multi-port fiber optic connector adapter, generally designated 400. The connector adapter 400 comprises a housing 410, in which a plurality of ports, generally designated 50, are formed on opposing lateral sides of the housing 410. Thus, there are ports 50 formed on both lateral sides of the housing 410, including a first subset of eight (8) ports 50 formed on a first lateral side of the housing 410 and a second subset of eight (8) ports 50 formed on a second lateral side of the housing 410. Each port 50 of the first subset of ports 50 extends towards a corresponding port 50 of the second subset of ports 50, such that a plurality of cavities or passages (e.g., volumetric regions) are formed extending between one of the ports 50 of the first subset of ports 50 and a coaxially aligned one of the ports 50 of the second subset of ports 50. Thus, there are as many cavities defined through the housing 410 as there are pairs of ports 50 on the opposing lateral sides of the housing 410. In the example embodiment shown, the cavities are fully separated or isolated from each other in the z-direction by internal walls 412, which extend the full height of the cavity formed by such internal wall 412 within the housing 410. In some embodiments, the internal walls 412 may extend over only a portion of the height of the housing 410, in which case the cavities extending between respective pairs of ports 50 would not be separated or isolated from each other in the z-direction.

The connector adapter 400 comprises an extension 420 that extends away from the housing 410 in the x-direction from both of the lateral walls of the housing 410. The extension 420 has side walls 424 that are generally coplanar with the outer (e.g., in the z-direction, extending in the x-y plane) side walls of the housing 410, such that the side walls 424 extend generally in the y-z plane. A ramp 422, or sloped surface, is provided between the side walls 424 of the extension 420. The extension 420 comprises dividers 426 (e.g., walls) that are spaced apart from each other in the z-direction and extend along the ramp 422 in the x-direction. The dividers 426 are each formed so as to have a top surface that is substantially coplanar with each other and extending in the x-z plane. A distance between the upper (e.g., in the y-direction) edges of the side walls 424 of the extension 420 and the sloped surface of the ramp 422 changes along the length of the extension in the x-direction. A distance between the upper (e.g., in the y-direction) edges of the dividers 426 of the extension 420 and the sloped surface of the ramp 422 also changes along the length of the extension in the x-direction. As shown, the dividers 426 can have a height above the sloped surface of the ramp 422 that decreases as a function of proximity to the lateral side of the housing 410 to which the extension 420 is attached. The dividers 426 of the extension 420 are preferably coplanar with the internal walls 412 or other dividers within the housing 410 that define the respective cavities within the housing 410.

The sloped surface of the ramp 422 tapers generally away from the lateral side of the housing 410 to which the extension 420 is attached. Thus, the sloped surface of the ramp 422 is, at the end farthest away from the lateral side of the housing 410, lower (i.e., in the y-direction) than where the extension 420 is connected at the lateral side of the housing 410. Stated somewhat differently, the sloped surface of the ramp 422 is inclined such that an angle α between the surfaces of the ramp 422 and cavity contacted by the connector is greater than 180° (see, e.g., FIG. 3, as the side view of the connector adapter 400 is substantially identical to the side view of the connector adapter 100, shown in FIG. 3, other than the fasteners 414 being in a different location from the fasteners 114).

The dividers 426 define channels therebetween, each channel being aligned with (e.g., coaxial to) one of the ports 50 of the connector adapter 400 on the same side of the housing 410 on which the extension 420 is attached. For the connector adapter 400, the quantity of channels, which are formed by and between the side walls 424 and dividers 426 (e.g., the outermost channels, in the z-direction) and between adjacent dividers 426 (e.g., the inner channels), is the same as the quantity of ports 50 of the connector adapter 400. The distance between (e.g., in the z-direction) the dividers 426 is the same as or wider than the width of the connector to be inserted within the port 50 of the connector adapter 400. Thus, during insertion, the connector rests on the ramp 422 within one of the channels, which corresponds to the port 50 into which the connector is to be inserted, and can be slid along the ramp 422 in the direction of insertion (e.g., in the x-direction), such that this channel guides the connector into the port 50 of the connector adapter 400 designated to receive the connector therein. Thus, the extension 420 is configured to align each connector with one of the ports 50 into which the connector is to be inserted, such that an alignment of the connector and said port 50 is maintained by engagement of the connector within the corresponding channel as the connector is moved towards the port 50 designated to receive the connector therein. The extension 420 is configured such that the act of placing the connector within one of the channels self-aligns the connector with the port 50 associated with the channel. Thus, by using the extensions 420 described herein, misalignments between the cable connector and the port 50 that are known to cause damage to the ferrules of the fiber optic cable connector are advantageously prevented.

In some embodiments, only one lateral side 416 of the housing 410 may have an extension 420 attached thereto.

In some embodiments, the housing 410 and the extensions 420 are formed integrally. Preferably, the extensions 420 and the housing 410 are formed in a unitary manner, such as via an injection molding process. The housing 410 and the extensions 120 can be formed out of any suitable material, including plastic, ceramic, and/or metal.

The housing 410 has a fastener 414 configured to secure the housing 410 to a panel, such as a network patch panel. Any suitable fastener type may be used. The fastener is preferably of a type by which the housing 410 may be inserted and removed from the panel in a tool-less manner (e.g., manually).

Thus, during a method of use of the connector adapter 400, a connector attached at a terminal end of a fiber optic cable can be positioned to rest within a designated channel, the connector can be slid along the ramp 422 towards the port 50 into which such connector is to be inserted, and the connector can be inserted into such port 50 when the connector reaches the end of the ramp 422 at the lateral side of the housing 410.

FIG. 8 shows a fifth example embodiment of a multi-port fiber optic connector adapter, generally designated 500. The connector adapter 500 comprises a housing 510, in which a plurality of ports, generally designated 50, are formed on opposing lateral sides of the housing 510. Thus, there are ports 50 formed on both lateral sides of the housing 510, including a first subset of twelve (12) ports 50 formed on a first lateral side of the housing 510 and a second subset of twelve (12) ports 50 formed on a second lateral side of the housing 510. Each port 50 of the first subset of ports 50 extends towards a corresponding port 50 of the second subset of ports 50, such that a plurality of cavities or passages (e.g., volumetric regions) are formed extending between one of the ports 50 of the first subset of ports 50 and a coaxially aligned one of the ports 50 of the second subset of ports 50. Thus, there are as many cavities defined through the housing 510 as there are pairs of ports 50 on the opposing lateral sides of the housing 510. In the example embodiment shown, the cavities are fully separated or isolated from each other in the z-direction by internal walls 512, which extend the full height of the cavity formed by such internal wall 512 within the housing 510. In some embodiments, the internal walls 512 may extend over only a portion of the height of the housing 510, in which case the cavities extending between respective pairs of ports 50 would not be separated or isolated from each other in the z-direction.

The connector adapter 500 comprises an extension 520 that extends away from the housing 510 in the x-direction from both of the lateral walls of the housing 510. The extension 520 has side walls 524 that are generally coplanar with the outer (e.g., in the z-direction, extending in the x-y plane) side walls of the housing 510, such that the side walls 524 extend generally in the y-z plane. A ramp 522, or sloped surface, is provided between the side walls 524 of the extension 520. The extension 520 comprises dividers 526 (e.g., walls) that are spaced apart from each other in the z-direction and extend along the ramp 522 in the x-direction. The dividers 526 are each formed so as to have a top surface that is substantially coplanar with each other and extending in the x-z plane. A distance between the upper (e.g., in the y-direction) edges of the side walls 524 of the extension 520 and the sloped surface of the ramp 522 changes along the length of the extension in the x-direction. A distance between the upper (e.g., in the y-direction) edges of the dividers 526 of the extension 520 and the sloped surface of the ramp 522 also changes along the length of the extension in the x-direction. As shown, the dividers 526 can have a height above the sloped surface of the ramp 522 that decreases as a function of proximity to the lateral side of the housing 510 to which the extension 520 is attached. The dividers 526 of the extension 520 are preferably coplanar with the internal walls 512 or other dividers within the housing 510 that define the respective cavities within the housing 510.

The sloped surface of the ramp 522 tapers generally away from the lateral side of the housing 510 to which the extension 520 is attached. Thus, the sloped surface of the ramp 522 is, at the end farthest away from the lateral side of the housing 510, lower (i.e., in the y-direction) than where the extension 520 is connected at the lateral side of the housing 510. Stated somewhat differently, the sloped surface of the ramp 522 is inclined such that an angle α between the surfaces of the ramp 522 and cavity contacted by the connector is greater than 180° (see, e.g., FIG. 3, as the side view of the connector adapter 500 is substantially identical to the side view of the connector adapter 100, shown in FIG. 3, other than the fasteners 414 being in a different location from the fasteners 114).

The dividers 526 define channels therebetween, each channel being aligned with (e.g., coaxial to) one of the ports 50 of the connector adapter 500 on the same side of the housing 510 on which the extension 520 is attached. For the connector adapter 500, the quantity of channels, which are formed by and between the side walls 524 and dividers 526 (e.g., the outermost channels, in the z-direction) and between adjacent dividers 526 (e.g., the inner channels), is the same as the quantity of ports 50 of the connector adapter 500. The distance between (e.g., in the z-direction) the dividers 526 is the same as or wider than the width of the connector to be inserted within the port 50 of the connector adapter 500. Thus, during insertion, the connector rests on the ramp 522 within one of the channels, which corresponds to the port 50 into which the connector is to be inserted, and can be slid along the ramp 522 in the direction of insertion (e.g., in the x-direction), such that this channel guides the connector into the port 50 of the connector adapter 500 designated to receive the connector therein. Thus, the extension 520 is configured to align each connector with one of the ports 50 into which the connector is to be inserted, such that an alignment of the connector and said port 50 is maintained by engagement of the connector within the corresponding channel as the connector is moved towards the port 50 designated to receive the connector therein. The extension 520 is configured such that the act of placing the connector within one of the channels self-aligns the connector with the port 50 associated with the channel. Thus, by using the extensions 520 described herein, misalignments between the cable connector and the port 50 that are known to cause damage to the ferrules of the fiber optic cable connector are advantageously prevented.

In some embodiments, only one lateral side 416 of the housing 510 may have an extension 520 attached thereto.

In some embodiments, the housing 510 and the extensions 520 are formed integrally. Preferably, the extensions 520 and the housing 510 are formed in a unitary manner, such as via an injection molding process. The housing 510 and the extensions 120 can be formed out of any suitable material, including plastic, ceramic, and/or metal.

The housing 510 has a fastener 514 configured to secure the housing 510 to a panel, such as a network patch panel. Any suitable fastener type may be used. The fastener is preferably of a type by which the housing 510 may be inserted and removed from the panel in a tool-less manner (e.g., manually).

Thus, during a method of use of the connector adapter 500, a connector attached at a terminal end of a fiber optic cable can be positioned to rest within a designated channel, the connector can be slid along the ramp 522 towards the port 50 into which such connector is to be inserted, and the connector can be inserted into such port 50 when the connector reaches the end of the ramp 522 at the lateral side of the housing 510.

The ports 50 disclosed herein are of a type suitable for coupling together terminated connectors of fiber optic cables. An example of a suitable fiber optic cable connector includes a very small form factor (VSFF) multi-fiber optical connector. These connector adapters are configured for insertion or attachment to a panel, preferably, a network patch panel. Thus, a network patch panel comprising a panel and a plurality of the presently disclosed connector adapters is also disclosed herein. Similarly, a network installation comprising such a network patch panel and a plurality of cables with connectors inserted into the ports 50 of the presently disclosed connector adapters is also disclosed herein.

While the present disclosure refers to certain embodiments, numerous modifications, alterations, and changes to the described embodiments are possible without departing from the sphere and scope of the present disclosure, as defined in the appended claim(s). Accordingly, it is intended that the present disclosure not be limited to the described embodiments, but that it has the full scope defined by the language of the following claims, and equivalents thereof. The discussion of any embodiment is meant only to be explanatory and is not intended to suggest that the scope of the disclosure, including the claims, is limited to these embodiments. In other words, while illustrative embodiments of the disclosure have been described in detail herein, it is to be understood that the inventive concepts may be otherwise variously embodied and employed, and that the appended claims are intended to be construed to include such variations, except as limited by the prior art.

The foregoing discussion has been presented for purposes of illustration and description and is not intended to limit the disclosure to the form or forms disclosed herein. For example, various features of the disclosure are grouped together in one or more aspects, embodiments, or configurations for the purpose of streamlining the disclosure. However, it should be understood that various features of the certain aspects, embodiments, or configurations of the disclosure may be combined in alternate aspects, embodiments, or configurations. Moreover, the following claims are hereby incorporated into this Detailed Description by this reference, with each claim standing on its own as a separate embodiment of the present disclosure.

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

The phrases “at least one”, “one or more”, and “and/or”, as used herein, are open-ended expressions that are both conjunctive and disjunctive in operation. The terms “a” (or “an”), “one or more” and “at least one” can be used interchangeably herein. All directional references (e.g., proximal, distal, upper, lower, upward, downward, left, right, lateral, longitudinal, front, back, top, bottom, above, below, vertical, horizontal, radial, axial, clockwise, and counterclockwise) are only used for identification purposes to aid the reader's understanding of the present disclosure, and do not create limitations, particularly as to the position, orientation, or use of this disclosure. Connection references (e.g., engaged, attached, coupled, connected, and joined) are to be construed broadly and may include intermediate members between a collection of elements and relative to movement between elements unless otherwise indicated. As such, connection references do not necessarily infer that two elements are directly connected and in fixed relation to each other. All rotational references describe relative movement between the various elements. Identification references (e.g., primary, secondary, first, second, third, fourth, etc.) are not intended to connote importance or priority but are used to distinguish one feature from another. The drawings are for purposes of illustration only and the dimensions, positions, order and relative to sizes reflected in the drawings attached hereto may vary.

1. A connector adapter for coupling cables together, the connector adapter comprising:
a housing;
a plurality of ports formed within the housing, wherein a first subset of the plurality of ports is formed on a first lateral side of the housing and a second subset of the plurality of ports is formed on a second lateral side of the housing; and
a first extension that is attached to the first lateral side of the housing and extends away from the housing;
wherein the first extension is configured to support and guide a connector attached to one of the cables into one of the first subset of the plurality of ports during insertion of the connector therein;
wherein the first subset of the plurality of ports extends into the housing in a direction of the second subset of the plurality of ports; and
wherein the second subset of the plurality of ports extends into the housing in a direction of the first subset of the plurality of ports.

2. The connector adapter of claim 1, wherein the first extension comprises a plurality of channels that are defined by dividers formed between adjacent ports of the first subset of the plurality of ports.

3. The connector adapter of claim 2, wherein a quantity of the plurality of channels is the same as a quantity of the first subset of the plurality of ports.

4. The connector adapter of claim 2, wherein the first extension has a sloped surface on which the connector of the cable being inserted is supported, the sloped surface being angled such that, at the first lateral side of the housing, the sloped surface and the first subset of the plurality of ports are continuous with each other.

5. The connector adapter of claim 4, wherein the sloped surface and a bottom surface of the first subset of the plurality of ports are arranged at an obtuse angle relative to each other.

6. The connector adapter of claim 5, wherein, at the first lateral side of the housing, the sloped surface and the bottom surface of the first subset of the plurality of ports are at a same height as each other.

7. The connector adapter of claim 5, wherein an edge of the sloped surface where the sloped surface is attached to the bottom is coplanar with the bottom surface of the first subset of the plurality of ports and all other parts of the sloped surface are below plane defined by the bottom surface of the first subset of the plurality of ports.

8. The connector adapter of claim 2, wherein each channel of the plurality of channels is coaxial with a port of the first subset of the plurality of ports.

9. The connector adapter of claim 1, wherein the first extension comprises a ramp.

10. The connector adapter of claim 9, wherein, during insertion of the connector into a port of the first subset of the plurality of ports, the ramp is configured such that the connector slides along the first extension and a ferrule of the connector does not directly contact the connector adapter.

11. The connector adapter of claim 1, wherein the first extension and the housing have a unitary or monolithic structure.

12. The connector adapter of claim 1, comprising a second extension that is attached to the second lateral side of the housing and extends away from the housing, wherein the second extension is configured to support and guide a connector attached to one of the cables into one of the second subset of the plurality of ports during insertion of the connector therein.

13. The connector adapter of claim 12, wherein the second extension comprises a plurality of channels that are defined by dividers formed between adjacent ports of the second subset of the plurality of ports.

14. The connector adapter of claim 13, wherein a quantity of the plurality of channels is the same as a quantity of the second subset of the plurality of ports.

15. The connector adapter of claim 13, wherein the second extension has a sloped surface on which the connector of the cable being inserted is supported, the sloped surface being angled such that, at the second lateral side of the housing, the sloped surface and the second subset of the plurality of ports are continuous with each other.

16. The connector adapter of claim 15, wherein the sloped surface and a bottom surface of the second subset of the plurality of ports are arranged at an obtuse angle relative to each other.

17. The connector adapter of claim 16, wherein, at the second lateral side of the housing, the sloped surface and the bottom surface of the second subset of the plurality of ports are at a same height as each other.

18. The connector adapter of claim 16, wherein an edge of the sloped surface where the sloped surface is attached to the bottom is coplanar with the bottom surface of the second subset of the plurality of ports and all other parts of the sloped surface are below plane defined by the bottom surface of the second subset of the plurality of ports.

19. The connector adapter of claim 13, wherein each channel of the plurality of channels is coaxial with a port of the second subset of the plurality of ports.

20. The connector adapter of claim 12, wherein the second extension comprises a ramp.

21. The connector adapter of claim 12, wherein the first extension, the second extension, and the housing have a unitary or monolithic structure.

22. The connector adapter of claim 1, wherein each port of the first subset of the plurality of ports is formed as a continuous cavity with a corresponding port of the second subset of the plurality of ports, the continuous cavity extending from the first lateral side of the housing to the second lateral side of the housing.

23. The connector adapter of claim 12, wherein:
during insertion of the connector into a port of the first subset of the plurality of ports, the connector slides along the first extension and a ferrule of the connector does not directly contact the connector adapter; and
during insertion of the connector into a port of the second subset of the plurality of ports, the connector slides along the second extension and a ferrule of the connector does not directly contact the connector adapter.

24. A network installation comprising:
a network patch panel comprising a plurality of the connector adapters according to claim 1; and
a plurality of fiber optic cables, each of which has at least one connector thereof inserted into one of the plurality of connector adapters of the network patch panel.
